(19) United States
(12) Patent Application Publication
(10) Pub. No.: US 2025/0083822 A1
(43) Pub. Date: Mar. 13, 2025

(54) VENTILATION APPARATUS

(71) Applicant: Aviation Works Limited, London (GB)

(72) Inventors: Rob Boyle, London (GB); Tim Wakeford, London (GB)

(21) Appl. No.: 18/722,412

(22) PCT Filed: Dec. 21, 2022
(86) PCT No.: PCT/EP2022/087239

§ 371 Date: Jun. 20, 2024

(30) Foreign Application Priority Data
Dec. 21, 2021 (EP) 21216650.8

(51) Int. Cl. B64D 13/02; A62B 7/14; B64D 13/06

(52) U.S. Cl. CPC B64D 13/02; A62B 7/14; B64D 2013/067; B64D 2013/0681

(57) ABSTRACT

An apparatus for preparing a ventilation gas mixture, the apparatus comprising: a first gas feed configured to receive carbon dioxide via a first gas valve; a second gas feed configured to receive oxygen via a second gas valve; a gas mixing device configured to receive the carbon dioxide and the oxygen from the first and second gas feeds and combine the carbon dioxide with the oxygen in the gas mixing device to form a ventilation gas mixture; wherein the first and second gas valves are adjustable between an open position and a closed position in order to adjust the relative amounts of carbon dioxide and oxygen forming the ventilation gas mixture; and wherein the first and a second gas valves are arranged to be adjusted based on a G-force that is imparted on the apparatus.

### FIELD OF THE INVENTION

The present invention relates to an apparatus for preparing a ventilation gas mixture to aircraft pilots and crew members.

### BACKGROUND

During normal breathing, atmospheric pressure forces oxygen through the lungs' membrane into the bloodstream. As altitude increases, for example when inside an aircraft, atmospheric pressure decreases and the amount of oxygen forced into the blood also decreases. Whilst the percentage of oxygen in the air doesn't change, the partial pressure of oxygen (the amount of the air pressure in the lungs that is made up of oxygen) has decreased due to the decrease in atmospheric pressure. In order to ensure the same amount of oxygen enters the bloodstream at high altitudes, the partial pressure of oxygen is increased. This can be done by increasing the percentage of oxygen in the air. However, at very high altitudes, for example 40,000 feet and above, there isn't enough pressure in the atmosphere to allow the lungs to absorb safe levels of oxygen, even if 100% oxygen is being breathed. In this case, pressure must be added to the oxygen to force the oxygen through the lungs' membranes called pressure breathing. When combined with an external chest counter-pressure garment, this increase in pressure also helps increase blood pressure and force blood to the user's brain. A pressure breathing system forces pressurized oxygen into the lungs of a user, for example a pilot, when the user breathes and so oxygen is only supplied when a user breathes. The system can provide high concentrations of oxygen, for example between substantially 90%-100% oxygen, under positive pressure or a mixture of oxygen diluted with cabin air on a specific, altitude based schedule to maintain a safe oxygen saturation.

Operation of combat aircraft at increased positive normal acceleration causes the crew to experience increased G-force. G-force normally refers to the acceleration experienced when an aircraft is moved aggressively in the pitch axis, whereby the apparent weight of the aircraft occupants is significantly increased. A G-tolerance is the ability of a living subject to be exposed to G-forces without noticeable, or at least severe, consequences. High G-forces are therefore experienced by crew members of combat aircrafts due to increased accelerations and/or narrow flight radii, but may also be experienced in other aircrafts, vehicles, simulators and the like.

During aircraft maneuvering, combat aircraft are capable of changing pitch very rapidly. This is most often used for fighter aircraft in order to obtain a weapons solution onto the enemy aircraft, but is regularly used on other combat aircraft (e.g. tactical bombers, reconnaissance aircraft, and combat training aircraft), in order to remain below radar detection or to evade enemy fire, or train for those scenarios. The ability to safely achieve a higher G-force, through increased G-tolerance, provides a tactical advantage to a combat aircraft since it can enable faster weapons targeting or evasion from enemy fire.

Exposure to high G-forces causes the blood in a human body to be “pulled” towards the feet, and thus starving the brain of oxygen. As the G-force increases, the effect becomes more pronounced, initially with greying or tunnelling of vision, through the eventual loss of consciousness. Additionally, rapid application of G-force, even to lower levels, can cause sudden loss of consciousness. This loss of consciousness is generally referred to as G-induced Loss of Consciousness (GLoC). When this loss of consciousness happens to a pilot close to the ground, or with the aircraft velocity vector towards the ground, it can have catastrophic outcome.

Furthermore, repeated exposure to even moderate levels of elevated G-forces causes fatigue in aircrew which, over the course of a flight, can result in poor crew judgement or failure to complete mandatory tasks, e.g. missing items on a check list, or failing to notice fuel levels falling below a minimum level. Although clearly more benign than a GLoC event, this fatigue can still lead to catastrophic outcomes, especially when coupled with the complex tasks required to operate modern combat aircraft in busy airspace environments.

To help counter the effect of G-force a user, such as a pilot, may wear a special garment which applies a pressure to the user's body, such as the legs and/or the chest. When a chest pressure garment is used in combination with pressure breathing, it means that the air being forced into the lungs is being forced against the counter pressure applied by the garment. At increased G-forces, the pressure of the breathed air is increased in order to mechanically squeeze the body against the externally worn counter-pressure garment, to force blood up to the brain. However, some adverse effect of increased G-force may still present problems.

It would be advantageous to provide a system which is able to further mitigate the effects of high G-forces on aircraft crew.

### SUMMARY OF THE INVENTION

According to a first aspect there is provided an apparatus for preparing a ventilation gas mixture, the apparatus comprising: a first gas feed configured to receive carbon dioxide via a first gas valve; a second gas feed configured to receive oxygen via a second gas valve; a gas mixing device configured to receive the carbon dioxide and the oxygen from the first and second gas feeds and combine the carbon dioxide with the oxygen in the gas mixing device to form a ventilation gas mixture; wherein the first and second gas valves are adjustable between an open position and a closed position in order to adjust the relative amounts of carbon dioxide and oxygen forming the ventilation gas mixture; and wherein the first and a second gas valves are arranged to be adjusted based on a G-force that is imparted on the apparatus.

Adjusting the first and second gas valves based on the G-force that is experienced by the apparatus means that the amount of carbon dioxide and oxygen entering the gas mixing device is adjusted based on the G-force. Using G-force to adjust the gas valves provides an apparatus which responds quickly and efficiently to changes in G-force. This is important because the optimal amounts of carbon dioxide and oxygen present in the ventilation gas mixture change as G-force changes and so it is advantageous to provide an apparatus which can respond to the required changes quickly. This ensures that the ventilation gas mixture is suitable for the G-force being experienced by the apparatus, and thus by a user of the apparatus.

The amount of carbon dioxide and oxygen in the ventilation gas mixture is controlled depending on the size of the G-force experienced by the apparatus. The amount by which the first and second gas valves are adjusted may be proportional to the size of the G-force imparted on the apparatus. That is, as G-force increases, the amount by which the first and second gas valves are adjusted may also increase.

Preferably, the apparatus comprises a first mass. The first mass may be connected to the second gas valve. The second gas valve may be adjusted based on a G-force imparted on the first mass. In this case, the first mass may have a weight which varies with the G-force imparted on the first mass such that the second gas valve is adjusted based on the weight of the first mass.

The movement of the second gas valve can be controlled using the effect of G-force on the mass, and so movement of the second gas valve is as a result of the G-force imparted to the apparatus. The amount of oxygen is therefore controlled based on the G-force experienced by the apparatus. Preferably, the amount of oxygen in the gas mixing device is increased as the G-force experienced by the apparatus is increased. In this way, and in particular when combined with a counter pressure garment and anti-g trousers, the blood is pushed up towards the brain to counteract the g-force pulling the blood towards the feet, which helps force more oxygenated blood to the brain. This may also ensure that a user of the apparatus receives sufficient oxygen under high G-force.

An adjustment of the second gas valve may be arranged to indirectly cause an adjustment of the first gas valve. This may provide a simple apparatus which is able to adjust both the first and second gas valves based on the G-force imparted to the apparatus. In this case, both the first and second gas valves may be controlled by a single mechanism wherein the mechanism directly adjusts the second gas valve and indirectly adjusts the first gas valve.

In some examples, the first mass may be connected to the first gas valve, wherein the first gas valve may be adjusted based on the G-force imparted on the first mass. In this case, the first mass may be connected to both the first and the second gas valves. This means that the first gas valve may be adjusted based on a weight of the first mass, wherein the weight varies with the G-force imparted on the first mass in a similar manner to the second gas valve. In other words, an adjustment of the second gas valve may be arranged to directly cause an adjustment of the first gas valve. Thus, in this example, both the first and second gas valves may be controlled by a single mechanism wherein the mechanism directly adjusts the second gas valve and directly adjusts the first gas valve.

Preferably an adjustment of the second gas valve may be arranged to cause a change in a force applied to the first gas valve such that the first gas valve may be adjusted based on the change in force applied to first gas valve. The change in force may be a positive change or the change in force may be a negative change. The change in force may cause the first gas valve to at least partially open or the change in force may cause the first gas valve to at least partially close. The amount by which the first gas valve is adjusted may be proportional to the size of the change in the force.

The change in force may be a change in pressure applied to the first gas valve such that the first gas valve may be adjusted based on a change in pressure applied to the first gas valve. If the change in pressure is positive, the size of the force applied to the first gas valve may increase. If the change in pressure is negative, the size of the force applied to the first gas valve may decrease. In this way, the first gas valve may be adjusted based on a change in condition within the apparatus.

Preferably, the change in pressure is a change in air pressure within the gas mixing device. In this way, the response of the first gas valve is dependent on a change in air pressure within the gas mixing device and so the first gas valve can respond to changing conditions within the gas mixing device.

In some examples, the apparatus may comprise a second mass. The second mass may be connected to the first gas valve. The first gas value may be adjusted based on a G-force imparted on the second mass. In this example, the second mass may have a weight which varies with the G-force imparted on the second mass, and the first gas valve may be adjusted based on the weight of the second mass. The movement of the first gas valve can be controlled using the effect of G-force on the mass, and so movement of the first gas valve is as a result of the G-force imparted to the apparatus. The amount of carbon dioxide is therefore controlled based on the G-force experienced by the apparatus. Preferably, the amount of carbon dioxide in the gas mixing device is decreased as the G-force experienced by the apparatus is increased. This may help prevent the partial pressure of carbon dioxide from becoming too high, as G-force increases, which may help prevent carbon dioxide poisoning of a user of the apparatus, for example a pilot.

Preferably, an adjustment of the second gas valve towards an open position may be arranged to cause an adjustment of the first gas valve towards a closed position. This means that as the amount of oxygen in the gas mixing device increases, the amount of carbon dioxide in the gas mixing device decreases, as G-force increases. If the amount of carbon dioxide at high G-force conditions increases too much, the user will breathe in too much carbon dioxide from the ventilation gas mixture which could cause carbon dioxide poisoning. Thus, it is important during high G-force conditions to reduce the amount of carbon dioxide in the gas mixing device so that the partial pressure of carbon dioxide does not become too high.

In some examples, an adjustment of the second gas valve towards an open position may be arranged to cause an adjustment of the first gas valve towards an open position. This means that as the amount of oxygen in the gas mixing device increases, the amount of carbon dioxide in the gas mixing device is maintained and in some cases may increase, as G-force increases. If the amount of oxygen at high G-force becomes too high, the relative amount of carbon dioxide may become too small such that any beneficial effects from adding carbon dioxide to the ventilation gas mixture are no longer felt. Thus, in this case, carbon dioxide is allowed to flow into the gas mixing device, in small amounts, to ensure that the amount of carbon dioxide and thus the partial pressure of carbon dioxide remains constant, allowing the user to benefit from the effect of supplementing oxygen with carbon dioxide.

The first gas valve and the second gas valve may be configured to be adjusted substantially simultaneously. Moving the first and second gas valves at substantially the same time, ensures that the relatives proportions of oxygen and carbon dioxide are adjusted together at the same time. In particular, this may ensure that amount of carbon dioxide, and therefore the partial pressure of carbon dioxide, is reduced when the amount of oxygen, and therefore the partial pressure of oxygen, is increased.

The first gas valve and the second gas valve may be configured to be adjusted independently of each other. The first and second gas valves may move independently and at the same time as each other or the first and second gas valves may move independently and at different times to each other. Adjusting the first and second gas valves independently of each other, rather than dependent on each other, may provide more accurate adjustment of each of the first and second gas valves which leads to more accurate control of the amount of oxygen and carbon dioxide in the ventilation gas mixture. In this way, the independently adjustable first and second gas valves may be more sensitive and more responsive to G-forces being imparted on the apparatus.

The first and a second gas valves may be arranged to be adjusted electronically based on a G-force that is imparted on the apparatus. For example, the apparatus may comprise a sensor that may sense G-force applied to the apparatus. The sensor may form part of an electrical control system which may send signals to a controller which electrically adjusts the first and second gas valves based on the received signals.

In some examples the apparatus may comprise an altitude sensor which may determine the altitude of the apparatus. The altitude sensor may form part of an electrical control system which may send signals to a controller which electrically adjusts the first and second gas valves based on the received altitude signals. In some cases, the g force and/or the altitude sensor may form part of the existing aircraft avionics and they may be distinct (separate) from the apparatus.

It should be noted that reference to “first” and “second” are for identifying each of two similar components. The terms “first” and “second” are not intended to imply an order or a preference. Thus, a “first” component may also be a “second” component and vice versa.

According to another aspect there is provided an aircraft comprising the apparatus as described above.

According to another aspect there is provided a system comprising the apparatus as described above and a demand breathing apparatus, wherein the demand breathing apparatus is coupled to the apparatus as described above.

According to another aspect there is provided a method of adjusting first and second gas valves in an apparatus, wherein the apparatus comprises a gas mixing device, the method comprising the steps of: receiving, in a gas mixing device, carbon dioxide from a first gas feed via a first gas valve; receiving, in the gas mixing device, oxygen from a second gas feed via a second gas valve; combining, in the gas mixing device, the carbon dioxide with the oxygen to form a ventilation gas mixture; adjusting the first and second gas valves between an open position and a closed position in order to adjust the relative amounts of carbon dioxide and oxygen forming the ventilation gas mixture; wherein adjusting the first and a second gas valves is based on a G-force that is imparted on the apparatus.

According to another aspect there is provided an apparatus for preparing a ventilation gas mixture for pilots and crew of aircraft, the apparatus comprising: a first gas feed configured to receive carbon dioxide via a first gas valve; a second gas feed configured to receive oxygen via a second gas valve; a gas mixing device configured to receive the carbon dioxide and the oxygen from the first and second gas feeds and combine the carbon dioxide with the oxygen in the gas mixing device to form a ventilation gas mixture; and a valve adjuster configured to adjust the positions of the first gas valve and the second gas valve in order to adjust the relative amounts of carbon dioxide and oxygen forming the ventilation gas mixture.

The valve adjuster may be configured to adjust the positions of the first gas valve and the second gas valve depending on ambient air pressure.

The valve adjuster may be configured to adjust the positions of the first gas valve and the second gas valve in accordance with a pre-defined schedule.

The valve adjuster may comprise a diaphragm connected to each of the first and second gas valves such that movement of the diaphragm is arranged to cause movement of both the first and second gas valves.

The diaphragm may be arranged to cause both the first and the second gas valves to move towards the closed position and/or both the first and the second gas valves to move towards the open position.

A portion of the diaphragm may be exposed to the ambient air, and movement of the diaphragm may be dependent on the pressure of the ambient air.

### BRIEF DESCRIPTION OF THE DRAWINGS

Embodiments of the present invention will now be described by way of example only with reference to the accompanying drawings in which:

FIG. 1 shows a schematic view of an apparatus for preparing a ventilation gas mixture;

FIG. 2 is a cross-sectional view of part of an apparatus for preparing a ventilation gas mixture;

FIG. 3 is a cross-sectional view of part of an apparatus for preparing a ventilation gas mixture;

FIG. 4 is a cross-sectional view of part of an apparatus for preparing a ventilation gas mixture; and

FIG. 5 is a cross-sectional view of part of an apparatus for preparing a ventilation gas mixture.

### DETAILED DESCRIPTION

It has been found that there are significant benefits in terms of blood oxygenation, from introducing relatively small percentages of carbon dioxide into the ambient air at high altitude which effectively lowers the apparent altitude of the ambient air. Thus, to increase blood oxygenation small percentages of carbon dioxide can be introduced into the air breathed by the user.

Introducing a low volume of carbon dioxide to the ventilation air mix significantly improves a user's brain blood oxygen levels compared to breathing normal air. As a result, the G-tolerance of the user may be influenced by the amount of carbon dioxide supplied to the user. Adding a small percentage of carbon dioxide to breathing air allows a user to be exposed to higher accelerations, i.e. tolerance to G-forces increases, as well as reducing fatigue during G-force exposure.

The present description relates to systems and apparatuses used to provide a ventilating gas mixture comprising small amounts of carbon dioxide to a user, in order to enhance the G-tolerance of the user. In particular, relatively small quantities of carbon dioxide are added to the ventilation air, in order to allow the human body to better absorb and utilise oxygen, prioritising oxygenation of the brain, and mitigate the effects of G-forces and hypocapnia.

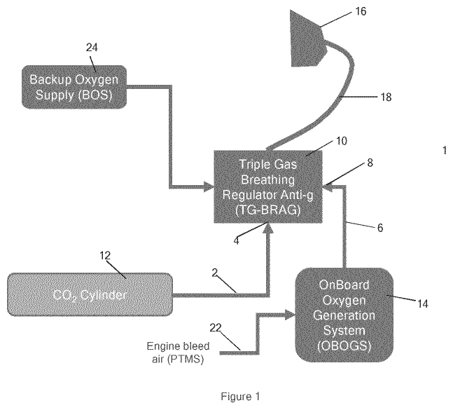

FIG. 1 illustrates an example apparatus 1 for preparing a ventilation gas mixture. The apparatus 1 comprises a first gas feed 2 configured to receive carbon dioxide via a first gas valve 4, a second gas feed 6 configured to receive oxygen via a second gas valve 8, and a gas mixing device 10 configured to receive the carbon dioxide and the oxygen from the first and second gas feeds and combine the carbon dioxide with the oxygen in the gas mixing device 10 to form a ventilation gas mixture.

The first gas feed 2 is connected to a first gas reservoir 12, which takes the form of a carbon dioxide source such as a pressurised carbon dioxide cylinder. The second gas feed 6 is connected to a second gas reservoir 14, which in this example takes the form of an on-board oxygen generation system (OBOGS). In other examples, the second gas reservoir 14 may take the form of a Molecular Sieve Oxygen Concentration Systems (MSOCS) or bottles of liquid or gaseous oxygen. The first and second gas reservoirs 12, 14 supply the carbon dioxide and oxygen to the gas mixing device 10. The apparatus 1 is connected to a ventilation mask 16 which receives the ventilation gas mixture from the gas mixing device via a third gas feed 18.

As shown in FIG. 1, the ventilation mask 16, first and second gas reservoirs 12, 14, and the gas mixing device 10 are fluidly connected to each other via the various gas feeds. In this context, the term gas also refers to gas mixtures or also gases or gas mixtures as a product of chemical reaction.

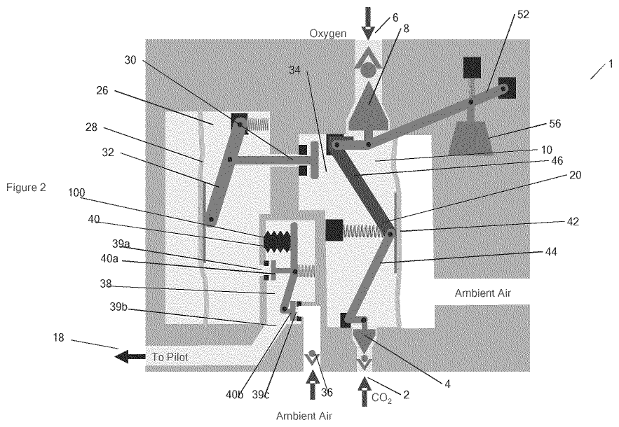

The apparatus 1 also comprises an adjuster 20, shown in FIG. 2, configured to adjust the positions of the first gas valve 4 and the second gas valve 8 in order to adjust the relative amounts of carbon dioxide and oxygen that are received in the gas mixing device 10 and form the ventilation gas mixture.

The first and second gas reservoirs 12, 14 store their respective gases under pressure, and so both the carbon dioxide and the oxygen enter the first and second gas feeds 2, 6 under pressure. Movement of each of the first and second gas valves 4, 8 adjusts the size of the opening between each gas feed 2, 6 and the gas mixing device 10, which in turn changes the pressure of the gas mixture within the gas mixing device 10. For example, when the gas valves 4, 8 are towards a closed position the size of the opening between the gas feed 2, 6 and the gas mixing device 10 is small. A limited amount of gas is therefore able to flow through the small opening and so the pressure in the gas mixing device 10 is low. Conversely, when the gas valves 4, 8 are towards an open position the size of the opening between the gas feed 2, 6 and the gas mixing device 10 is large. A large amount of gas is therefore able to flow through the bigger opening and so the pressure in the gas mixing device 10 increases.

The adjuster 20 can be thought of as a regulator because it regulates the relative proportions of carbon dioxide and oxygen in the ventilation gas mixture.

Generally, during operation, a user initially inhales the air from the gas mixing device 10 through the ventilation mask 16 which supplies the ventilation gas mixture to the user. The ventilation gas mixture generally comprises a mixture carbon dioxide and oxygen the relative amounts of each gas dependent on the altitude. As the altitude of the aircraft increase, the proportion of oxygen in the ventilation gas mixture increases until a point is reached where substantially 100% oxygen is supplied to the user (minus the desired carbon dioxide percentage). As discussed, pressure breathing is used in aircraft to increase the partial pressure of oxygen. The ventilation gas mixture supplied to the ventilation mask 16 from the gas mixing device 10 and inhaled by the user is therefore supplied under pressure during periods of pressure breathing.

The apparatus 1 generally include a number of non-return valves along each gas feed and at a general level, the apparatus is designed to ensure that the pressure of the gas leaving the gas mixing device 10 is substantially matched to the ambient air pressure, unless the altitude reaches such a level that pressure breathing is required. The ambient air pressure will continually fluctuate as the aircraft manoeuvres and the apparatus corrects for these fluctuations using the adjuster 20. That is, in general terms, the pressurisation and depressurisation of the gas mixing device 10 is controlled by the aircraft depending upon the G-force exerted on the apparatus. As high G is experienced, pressure breathing is initiated and so the pressure of the air within the gas mixing device 10 is increased.

Further details of the apparatus 1 and its operation will now be described.

The second gas reservoir 14, which acts as a source of oxygen, produces and supplies a high concentration of oxygen, for example 90%-100% and preferably near 100% oxygen, under pressure to the second gas feed 6, in this case from a conditioned engine bleed supply 22 by means of the principle of Pressure Swing Adsorption (PSA). An optional backup oxygen supply (BOS) 24 may be included which comprises at least one high pressure oxygen cylinder for providing backup oxygen for example in the event of loss of oxygen supply from the oxygen supply or during an ejection event.

Ventilation gas is delivered to a user only as the user inhales, or on demand. In this way the apparatus 1 may be considered as part of a demand-flow system. When the user holds their breath or exhales, the supply of ventilation gas is stopped. This helps reduce oxygen and carbon dioxide wastage, prolonging the duration of the oxygen and carbon dioxide supplies. The apparatus 1 may be adapted for use with more with one user. In this case, the third gas feed 18 may comprise one or more non-return valves, and a plurality of ventilation masks would be provided, each in communication with the third gas feed 18.

With reference to FIG. 2, the apparatus comprises a series of chambers through which the gases flow before reaching the user. A first chamber 26 comprises a first diaphragm 28 connected to a demand valve 30 via a moveable arm 32. Movement of the first diaphragm 28 therefore causes movement of the demand valve 30 between an open and closed position. When a user inhales through the ventilation mask 16 the pressure within the first chamber 26 is reduced causing the first diaphragm 28 to move in a first direction which subsequently opens the demand valve 30.

Oxygen from the second gas feed 6 and carbon dioxide from the first gas feed 2 flow into a second chamber 34 via the first and second gas valves 4, 8. The oxygen and carbon dioxide gases are mixed in the second chamber 34, and so the second chamber 34 forms part of the gas mixing device 10. The pressure of the oxygen and the carbon dioxide from the first and second gas feeds 2, 6 is adjusted by the adjuster 20 and then the oxygen and carbon dioxide gas mixture passes into the first chamber 26 and to the ventilation mask 16. The pressure of the gas mixture in the second chamber 34 is substantially equalized with the ambient pressure by the adjuster 20 to ensure that the user is not breathing the ventilation gas mixture under pressure. However, in some cases pressure breathing is desirable as mentioned elsewhere, for example at extreme altitude or when pulling G.

In order to balance the pressure of the gases, the adjuster 20 comprises a second diaphragm 42 which is connected to both the first and second gas valves 4, 8 through a series suitable arms 44, 46. Movement of the second diaphragm 42 causes movement of the first and second gas valves 4, 8, and so in this way movement of the second diaphragm 42 can be used to adjust the flow of carbon dioxide and oxygen into the gas mixing device 10.

When the first and second gas valves 4, 8 are open, large amounts of carbon dioxide and oxygen can flow into the second chamber 34. This increases the pressure inside the second gas chamber 34. This increased pressure exerts a force on the second diaphragm 42 causing the second diaphragm 42 to move. As can be seen in FIG. 2, one side of the second diaphragm 42 is exposed to the ambient air. The second diaphragm 42 moves to substantially balance the pressure experienced by either side of the second diaphragm 42. Thus, when the pressure inside the second chamber 34 is greater than the pressure of the ambient air, the second diaphragm 42 moves to increase the volume of the second camber 34 thus reducing the pressure. Since the second diaphragm 42 is connected to both the first and the second gas valves 4, 8, when the second diaphragm 42 moves to increase the size of the second chamber 34, the first and second valves are 4, 8 moved towards a closed position and so less gas can enter the second gas chamber 34. When less gas enters the second gas chamber 34 the pressure stops increasing. If the pressure in the second gas chamber 34 becomes lower than the ambient air pressure, the force of the ambient air pressure moves the second diaphragm 42 to reduce the size of the second chamber 34, which has the effect of opening the first and second gas valves 4, 8. This means more gas can flow into the second gas chamber 34 and balance the ambient air pressure.

When the user exhales, the pressure within the first chamber 26 is increased causing the first diaphragm 28 to move in a second direction which subsequently closes the demand valve 30 and stops the flow of the ventilation gas mixture. In addition a biasing means, for example a spring, connected to the moveable arm 32 may also act on the moveable arm 32 to cause the demand valve 30 to close. In this case, oxygen and carbon dioxide flowing into the second gas chamber 34 may collect in the second gas chamber 34. Exhaled air escapes through ports in the ventilation mask 16.

The apparatus 1 dilutes the ventilation gas mixture of oxygen and carbon dioxide with ambient air each time a breath is drawn, the amount of dilution depending on the cabin altitude. This may help reduce the percentage of oxygen and carbon dioxide to the correct levels for the ventilation gas mixture.

Ambient air enters the apparatus 1 via an intake valve and flows into an ambient air chamber 38. The ambient air chamber 38 is located between the first chamber 26 and the third gas feed 18 to the ventilation mask 16. The ambient air chamber comprises a series of openings 39a, 39b, 39c through which various gases flow into and out of the ambient air chamber 38. The size of opening 39a between the ambient air chamber 39 and the first chamber 26 and the size of opening 39c between the intake valve 26 and the ambient air chamber 38 are controlled by a metering mechanism 40 comprising two metering valves 40a, 40b.

As altitude increases, the metering mechanism 40 allows more oxygen to flow into the ambient air chamber 38 via the metering valve 40a which opens the corresponding opening 39a, and less ambient air to flow into the ambient air chamber 38 via the other metering valve 40b which closes the corresponding opening 39c. The metering mechanism 40 adjusts the flow of gases through the metering valve 40a, 40b according to predefined characteristics of a barometric capsule 100, which changes shape as the ambient pressure changes.

The gas mixing device 10 receives a high concentration of oxygen, for example 80%-100% oxygen, from the second gas reservoir 14, such as an OBOGS, and the added carbon dioxide displaces the oxygen. However, it is important to preserve the partial pressure of oxygen and ensure that the partial pressure of oxygen is not reduced by the addition of the carbon dioxide, especially at altitude, as this could contribute to reduced G-force tolerance.

As previously stated, when G-force increases so does the gas pressure and the partial pressures of both oxygen and carbon dioxide. However, it is important to make sure that the carbon dioxide partial pressure does not become too high, otherwise the pilot may breathe in too much carbon dioxide and risk carbon dioxide poisoning. Therefore, in order to prevent this, as the G-force increases, the quantity of carbon dioxide allowed to enter the gas mixing device 10 is reduced. As such, in high G-force conditions, the partial pressure of oxygen is increased but the partial pressure of carbon dioxide is decreased. This is achieved by adjusting the first and second gas valves 4, 8 based on a G-force that is imparted on the apparatus 1, as will now be described.

The apparatus 1 comprises an arm 52 connected to the second gas valve 8, which may be referred to as an oxygen arm 52. Movement of the arm 52 causes movement of the second gas valve 8. The arm 52 comprises a mass 56 attached at a point along the length of the arm, as shown in FIG. 2. Under normal flight conditions the weight of the mass 56 corresponds to the size in kilograms of the mass 56. However, as G-forces increase, the weight of the mass 56 also increases. As the weight of the mass 56 increases, so does the corresponding force applied to the arm 52 by the mass 56. This means that the second gas valve 8 is adjusted based on a G-force imparted on the oxygen mass 56. In particular, the oxygen mass 56 has a weight which varies with the G-force imparted on the oxygen mass 56 such that the second gas valve 8 is adjusted based on the weight of the mass 56.

As the weight of the mass 56 increases, a greater force is applied to the oxygen arm 52 causing movement of the oxygen arm 52 such that the second gas valve 8 moves towards the open position. Thus, movement of the oxygen arm 52, caused by the weight of the second mass 56 increasing, increases the flow of oxygen into the gas mixing device 10. The effect of increasing G-forces has the effect of opening the second gas valve 8.

In this example, the adjustment of the second gas valve 8 indirectly causes an adjustment of the first gas valve 4. This is because the adjustment of the second gas valve 8 causes a change in a force applied to the first gas valve 4 such that the first gas valve 4 is adjusted based on this change in force. As the second gas valve 8 opens, more oxygen flows into the gas mixing device 10 which causes the gas pressure inside the gas mixing device 10 to increase. This increase in pressure means that a greater gas pressure is exerted on the first gas valve 4 by the ventilation gas mixture. Here, the gas pressure is the force that is applied to the first gas valve 4. Applying a force to the first gas valve 4 causes the first gas valve 4 to move towards the closed position, reducing the amount of carbon dioxide that can enter the gas mixing device 10. Thus, in this example, as the second gas valve 8 opens, the first gas valve 4 closes. The effect of increasing G-forces therefore has an opposite effect on each of the first and second gas valves 4, 8. As discussed, this is important because if the amount of carbon dioxide becomes too high, such that the partial pressure of carbon dioxide becomes too high under high G-forces, there will be too much carbon dioxide in the ventilation gas mixture which has the risk of poisoning the user. By reducing the amount of carbon dioxide in the ventilation gas mixture at high G-forces, the risk of carbon dioxide poisoning to the user is reduced. However, since some carbon dioxide will be present in the ventilation gas mixture, the user is still able to benefit from the advantageous effects of small amounts of carbon dioxide in the ventilation gas mixture, as explained previously. Additionally, elevated levels of carbon dioxide will remain in the body and the bloodstream for a short while after carbon dioxide has stopped being supplied in the ventilation gas mixture and so, again, the user is still able to benefit from the advantageous effects of the carbon dioxide present in their bloodstream.

By adjusting the flow of carbon dioxide and oxygen by adjusting the positions of the first and second gas valves 4, 8, the correct proportion of carbon dioxide and oxygen can be maintained under high G-forces. In particular, it can be ensured that the partial pressure of carbon dioxide does not become too high under high G-force conditions. As the G-force increases, the oxygen partial pressure increases which has the effect of partially closing the carbon dioxide valve 4, reducing the carbon dioxide flow rate and limiting the carbon dioxide partial pressure.

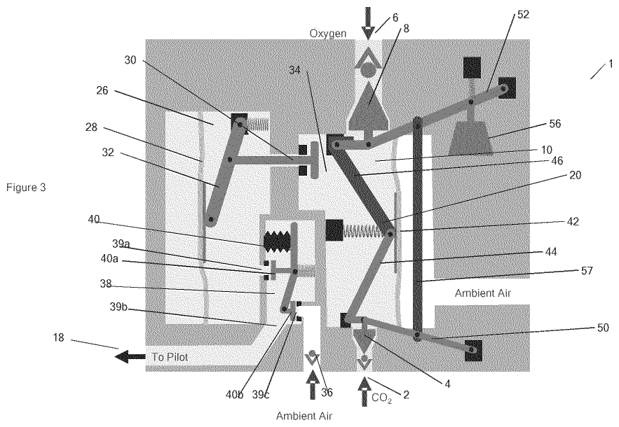

FIG. 3 shows a second example which is similar to that of FIG. 2. However, in this example, the adjustment of the second gas valve 8 directly causes an adjustment of the first gas valve 4. This is because the mass 56 is connected to the second gas valve 4 as well as the first gas valve 8, via a cross-link 57. The cross-link 57 is rigid so that G-force imparted on the mass 56 causes the second valve 4 to be adjusted when the first valve 8 is adjusted. In other words, the first gas valve 4 is adjusted based on the weight of the oxygen mass 56, which varies with the G-force imparted on the oxygen mass 56.

As before, in this second example, as the second gas valve 8 opens, the first gas valve 4 closes and the effect of increasing G-forces therefore has an opposite effect on each of the first and second gas valves 4, 8. In this case, the force applied to the first gas valve 4 is applied directly through the cross-link 57. This example uses the same principle as the previous example, but in the case a single mass 56 and cross-link 57 are used to drive both the first and second gas valves 4, 8. This example arrangement similarly ensures that partial pressure of carbon dioxide does not become too high under high G-force conditions, reducing the likelihood of carbon dioxide poisoning.

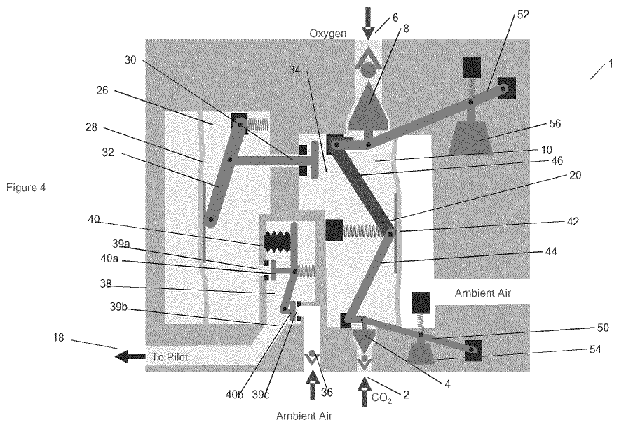

FIG. 4 shows a third example arrangement, configured to achieve the same effect of ensuring that partial pressure of carbon dioxide does not become too high under high G-force conditions. In this third example, the apparatus 1 comprises another arm 50, which may be referred to as a carbon dioxide arm 50. This arm 50 is connected to the first gas valve 4 and the oxygen arm 52 is only connected to the second gas valve 8. Movement of each arm 50, 52 causes movement of the corresponding valve. For example movement of the carbon dioxide arm 50 causes movement of the first gas valve 4 and movement of the oxygen arm 52 causes movement of the second gas valve 8. The carbon dioxide arm 50 and the oxygen arm 52 are able to move independently of each other, and in some cases they will move independently but at the same time as each other.

In a similar manner to the oxygen arm 52, the carbon dioxide arm 50 comprises a mass 54 attached at a point along the length of the arm 50, as shown in FIG. 4. Thus, in this arrangement, a first mass 54 is attached to the carbon dioxide arm 50 and a second mass 56 is attached to the oxygen arm 52. As before, under normal flight conditions the weight of each mass 54, 56 corresponds to the size in kilograms of each mass 54, 56. When G-forces increase, the weight of each mass 54, 56 also increases and so does the corresponding force applied to each arm 50, 52 by their masses 54, 56.

The second mass 56 functions as described previously, with reference to FIGS. 2 and 3, to open the second vale 8. Conversely, in this example, as the weight of the first mass 54 increases, a greater force is applied to the carbon dioxide arm 50 causing movement of the carbon dioxide arm 50 such that the first gas valve 4 moves towards the closed position. Thus, movement of the carbon dioxide arm 50, caused by the weight of the first mass 54 increasing, reduces the flow of carbon dioxide into the gas mixing device 10. Thus, the effect of the G-force imparted on each of the first and second masses 54, 56 is opposite, and so the effect of increasing G-forces therefore has an opposite effect on each of the first and second gas valves 4, 8.

In this example shown in FIG. 4, the first and second gas valves 4, 8 are moved independently of each other due to the effect of G-force of each of the masses 54, 56. The first valve 4 is not adjusted based on direct or indirect application of a force resulting from movement of the second valve 8. Instead, the first valve 4 is adjusted based on a direct application of a force resulting from an increase in weight of the first mass 54.

The two-mass arrangement in FIG. 4 may allow more accurate control of the first valve 4 as G-force changes compared to that of the arrangement in FIGS. 2 and 3.

In all the arrangements in FIGS. 2, 3, and 4, as the oxygen valve 8 is moved towards an open position, the carbon dioxide valve 4 is moved towards a closed position. These arrangements ensure that the user benefits from the addition of small amount of carbon dioxide in the ventilation gas mixture, whilst ensuring that the user is not a risk of carbon dioxide poisoning.

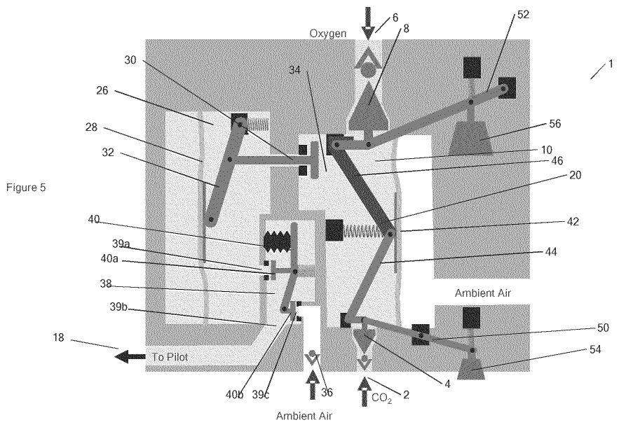

FIG. 5 shows a slight modification of the arrangement in FIG. 4. In this example, the position of the first mass 54 along the carbon dioxide arm 50 is modified so that when the weight of the first mass 54 increase, with increasing G-force, the increased for applied to the arm 50 by the masses 54 has the effect of opening the first gas valve 4. Thus, in the arrangement, movement of the carbon dioxide arm 50, caused by the weight of the first mass 54 increasing, increases the flow of carbon dioxide into the gas mixing device 10. As such, the effect of the G-force imparted on each of the first and second masses 54, 56 is the same in this example, and so the effect of increasing G-forces has the same effect of opening each of the first and second gas valves 4, 8. This ensures that the partial pressure of carbon dioxide is maintained, rather the reduced, as G-force increases. This may be required if the partial pressure of oxygen is becoming too high and the benefits of the carbon dioxide in the gas mixture are not being felt by the user.

1. An apparatus for preparing a ventilation gas mixture, the apparatus comprising:
a first gas feed configured to receive carbon dioxide via a first gas valve;
a second gas feed configured to receive oxygen via a second gas valve; and
a gas mixing device configured to receive the carbon dioxide and the oxygen from the first and second gas feeds and combine the carbon dioxide with the oxygen in the gas mixing device to form a ventilation gas mixture;
wherein the first and second gas valves are adjustable between an open position and a closed position in order to adjust the relative amounts of carbon dioxide and oxygen forming the ventilation gas mixture; and
wherein the first and a second gas valves are arranged to be adjusted based on a G-force that is imparted on the apparatus.

2. The apparatus of claim 1 further comprising a first mass, connected to the second gas valve, wherein the second gas valve is adjusted based on a G-force imparted on the first mass.

3. The apparatus of claim 2 wherein an adjustment of the second gas valve is arranged to indirectly cause an adjustment of the first gas valve.

4. The apparatus of claim 2 wherein the first mass is also connected to the first gas valve, wherein the first gas valve is adjusted based on the G-force imparted on the first mass.

5. The apparatus of claim 2 wherein an adjustment of the second gas valve is arranged to cause a change in a force applied to the first gas valve such that the first gas valve is adjusted based on the change in force applied to first gas valve.

6. The apparatus of claim 5 wherein the change in force is a change in pressure applied to the first gas valve such that the first gas valve is adjusted based on a change in pressure applied to the first gas valve, preferably wherein the change in pressure is a change in air pressure within the gas mixing device.

7. The apparatus of claim 2 further comprising a second mass, connected to the first gas valve, wherein the first gas valve is adjusted based on a G-force imparted on the second mass.

8. The apparatus of claim 1 wherein an adjustment of the second gas valve towards an open position is arranged to cause an adjustment of the first gas valve towards a closed position.

9. The apparatus of claim 7 wherein an adjustment of the second gas valve towards an open position is arranged to cause an adjustment of the first gas valve towards an open position.

10. The apparatus of claim 1 where the first and second gas valves are configured to move substantially simultaneously.

11. The apparatus of claim 9 where the first and second gas valves are configured to move independently of each other.

12. The apparatus of claim 1 wherein the first and second gas valves are arranged to be adjusted electronically based on a G-force that is imparted on the apparatus.

13. (canceled)

14. A system comprising:
the apparatus according to claim 1; and
a demand breathing apparatus;
wherein the demand breathing apparatus is coupled to the apparatus according to claim 1.

15. A method of adjusting first and second gas valves in an apparatus, wherein the apparatus comprises a gas mixing device, the method comprising the steps of:
receiving, in a gas mixing device, carbon dioxide from a first gas feed via a first gas valve;
receiving, in the gas mixing device, oxygen from a second gas feed via a second gas valve;
combining, in the gas mixing device, the carbon dioxide with the oxygen to form a ventilation gas mixture; and
adjusting the first and second gas valves between an open position and a closed position in order to adjust the relative amounts of carbon dioxide and oxygen forming the ventilation gas mixture;
wherein adjusting the first and second gas valves is based on a G-force that is imparted on the apparatus.

16. The apparatus of claim 4 wherein an adjustment of the second gas valve is arranged to directly cause an adjustment of the first gas valve.
